(19) United States
(12) Patent Application Publication
(10) Pub. No.: US 2020/0378807 A1
(43) Pub. Date: Dec. 3, 2020

(54) ELECTRONIC DEVICE

(71) Applicant: FUJITSU LIMITED, Kawasaki-shi (JP)

(72) Inventor: Shinichi TAJIMA, Kawasaki (JP)

(73) Assignee: FUJITSU LIMITED, Kawasaki-shi (JP)

(21) Appl. No.: 16/847,713

(22) Filed: Apr. 14, 2020

(30) Foreign Application Priority Data
May 27, 2019 (JP) 2019-098627

(51) Int. Cl. G01D 11/26; G01N 27/22; G01K 1/08; G01D 11/24

(52) U.S. Cl. CPC G01D 11/26; G01D 11/245; G01K 1/08; G01N 27/223

(57) ABSTRACT

An electronic device includes: a flexible substrate which has flexibility and in which an electronic component and a sensor coupled to the electronic component are mounted over a component mounting surface; a sealing member which has flexibility, which has a sensor accommodating portion provided so as to correspond to a mounting position of the sensor, which also has at least one opening that allows communication between inside and outside of the sensor accommodating portion, and which covers at least the component mounting surface of the flexible substrate; and a drip-proof member which has air permeability, which has at least one deformation allowing portion configured to follow deformation of the sealing member, and which is stuck to the sealing member over the at least one opening.

### CROSS-REFERENCE TO RELA I ED APPLICATION

This application is based upon and claims the benefit of priority of the prior Japanese Patent Application No. 2019-98627, filed on May 27, 2019, the entire contents of which are incorporated herein by reference.

### FIELD

The embodiments discussed herein are related to an electronic device.

### BACKGROUND

For example, there are known electronic devices that include a sensor which measures the temperature or the humidity of the outside air. Some of such electronic devices include an air permeable film-shaped drip-proof member to allow the sensor to be in contact with the outside air and ensure the waterproofness of the electronic devices.

Related art is disclosed in, for example, Japanese Laid-open Patent Publication Nos. 2002-286686, 2007-81976, and 2007-304020.

### SUMMARY

According to an aspect of the embodiments, an electronic device includes: a flexible substrate which has flexibility and in which an electronic component and a sensor coupled to the electronic component are mounted over a component mounting surface; a sealing member which has flexibility, which has a sensor accommodating portion provided so as to correspond to a mounting position of the sensor, which also has at least one opening that allows communication between inside and outside of the sensor accommodating portion, and which covers at least the component mounting surface of the flexible substrate; and a drip-proof member which has air permeability, which has at least one deformation allowing portion configured to follow deformation of the sealing member, and which is stuck to the sealing member over the at least one opening.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective view of an electronic device according to a first embodiment;

FIG. 2 is an exploded perspective view of the electronic device according to the first embodiment;

FIG. 3A is a front view of a sealing member included in the electronic device according to the first embodiment, and FIG. 3B is a bottom view of the sealing member;

FIG. 4 is an explanatory view of a frame member and a drip-proof member attached to an opening of the sealing member included in the electronic device according to the first embodiment;

FIG. 5A illustrates the frame member in a state in which the frame member is not subjected to bending deformation, and FIG. 5B is an explanatory view illustrating the frame member in a state in which the frame member is subjected to the bending deformation;

FIG. 6 is an explanatory view of a frame member and a drip-proof member according to a second embodiment;

FIG. 7 is an explanatory view of a frame member and a drip-proof member according to a third embodiment;

FIGS. 8A to 8C are a three-view drawing of the frame member according to the third embodiment, and out of FIGS. 8A to 8C, FIG. 8A is a front view, FIG. 8B is a plan view, and FIG. 8C is a side view;

FIG. 9 is an explanatory view of a frame member and a drip-proof member according to a fourth embodiment;

FIGS. 10A to 10C are a three-view drawing of the frame member according to the fourth embodiment, and out of FIGS. 10A to 10C, FIG. 10A is a front view, FIG. 10B is a plan view, and FIG. 10C is a side view;

FIG. 11 is an explanatory view of a frame member and a drip-proof member according to a fifth embodiment;

FIGS. 12A to 12C are a three-view drawing of the frame member according to the fifth embodiment, and out of FIGS. 12A to 12C, FIG. 12A is a front view, FIG. 12B is a plan view, and FIG. 12C is a side view;

FIG. 13 is an explanatory view of a frame member and a drip-proof member according to a sixth embodiment;

FIG. 14 is a bottom view of the drip-proof member according to the sixth embodiment;

FIG. 15 is an explanatory view of a frame member and a drip-proof member according to a seventh embodiment;

FIG. 16 is a side view of the drip-proof member attached to the frame member according to the seventh embodiment; and

FIG. 17 is a side view of a drip-proof member according to a modification.

### DESCRIPTION OF EMBODIMENTS

Nowadays, there are electronic devices that are formed of, for example, rubber, include a substrate having flexibility, and are deformable, for example, able to be bent. When the sensor which measures the temperature or the like of the outside air is mounted together with the drip-proof member in such deformable electronic devices, the film-shaped drip-proof member may be removed as a result of peeling off of the drip-proof member or damaged depending on a manner of the deformation of the electronic devices. In Japanese Laid-open Patent Publication No. 2002-286686, 2007-81976, or 2007-304020, deformation of the electronic devices is not considered, and accordingly, neither removal of the drip-proof member resulting from peeling off of the drip-proof member nor damage to the drip-proof member due to the deformation of the electronic device is suppressed.

According to an aspect, removal of a drip-proof member resulting from peeling off of the drip-proof member and damage to the drip-proof member provided in an electronic device when the electronic device is deformed may be suppressed.

Hereinafter, embodiments of the present disclosure will be described with reference to the accompanying drawings. In the drawings, the dimensions, ratios, or the like of parts are not necessarily illustrated to be completely consistent with those of the actual parts. Also in some drawings, for convenience of description, elements actually present are omitted or the elements are exaggerated in dimensions compared to the actual elements.

### First Embodiment

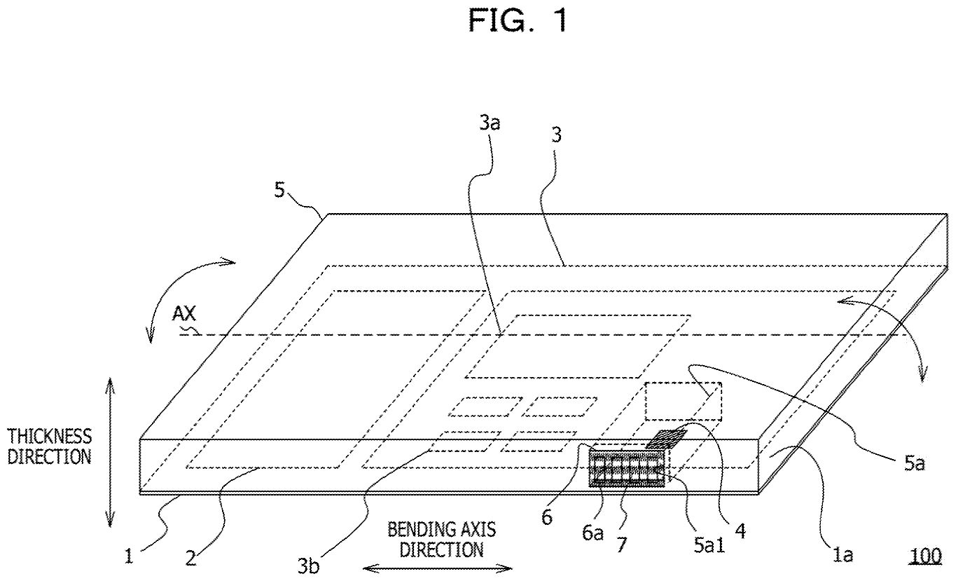

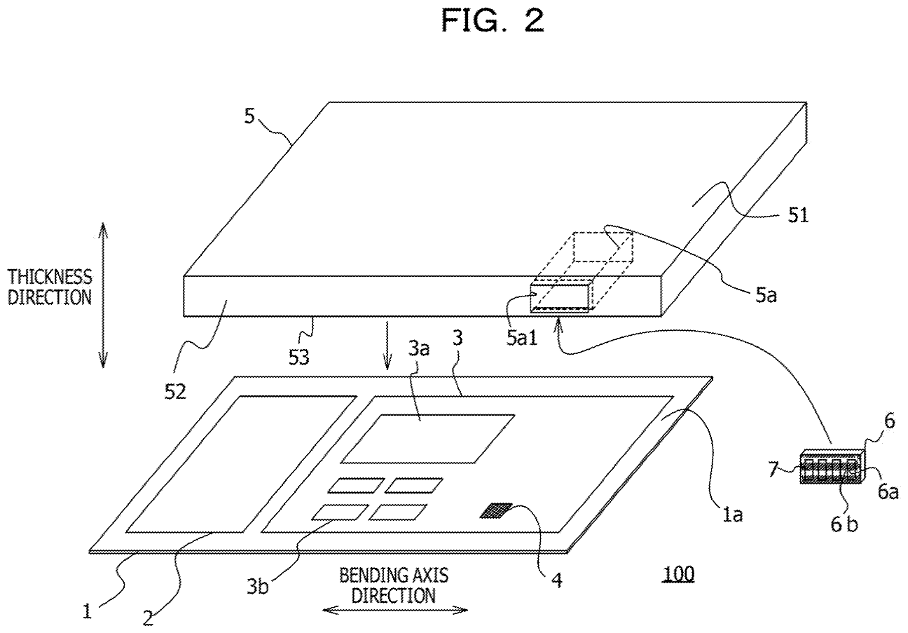

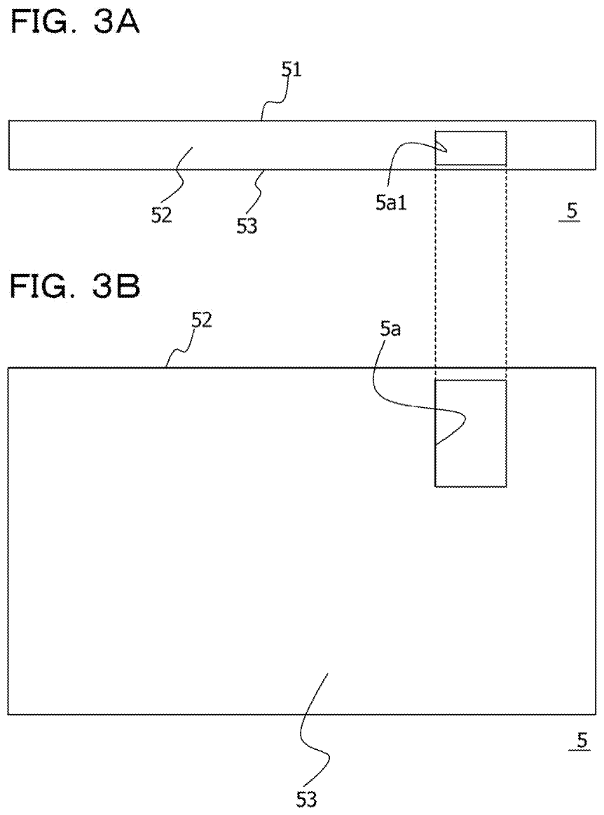

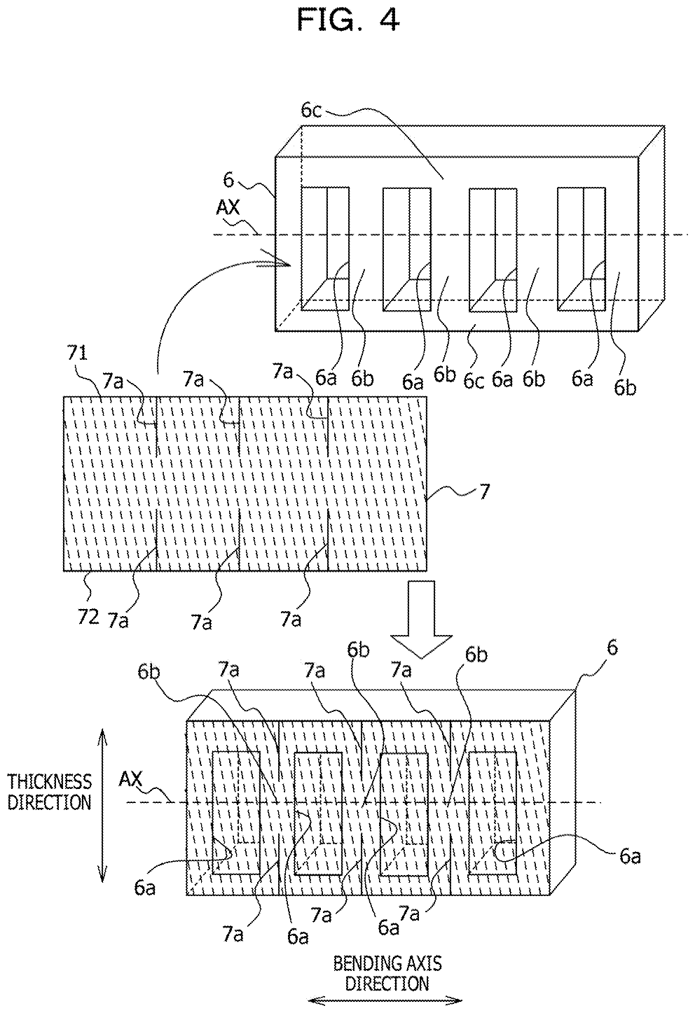

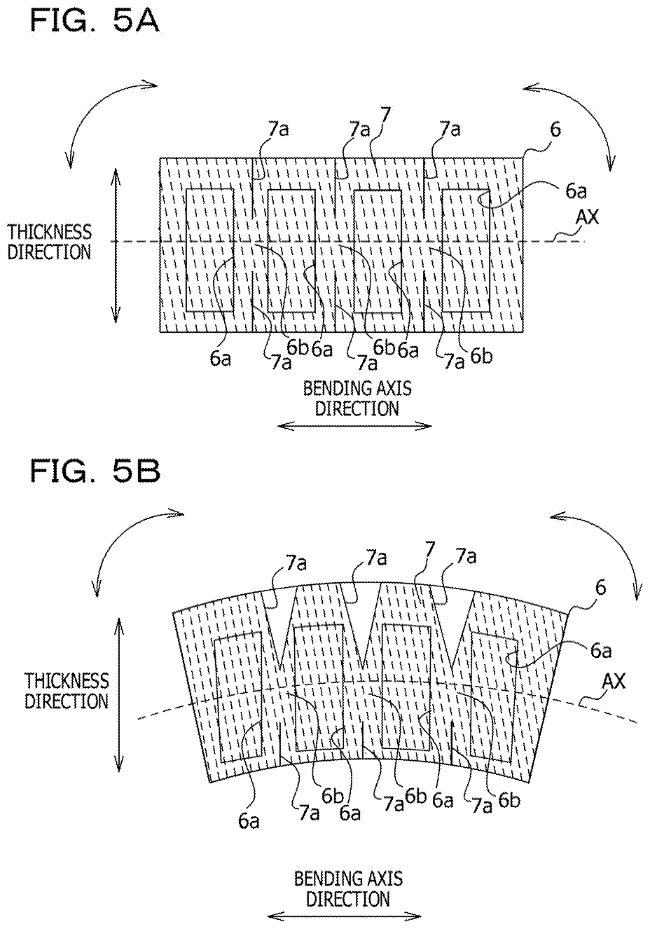

First, an electronic device 100 according to an embodiment is described with reference to FIGS. 1 to 58. FIG. 1 is a perspective view of the electronic device 100 according to the first embodiment. FIG. 2 is an exploded perspective view of the electronic device 100 according to the first embodiment. FIG. 3A is a front view of a sealing member 5 included in the electronic device 100 according to the first embodiment, and FIG. 38 is a bottom view of the sealing member 5. FIG. 4 is an explanatory view of a frame member 6 and a drip-proof member 7 attached to an opening 5a1 of the sealing member 5 included in the electronic device 100 according to the first embodiment. FIG. 5A illustrates the frame member 6 in a state in which the frame member 6 is not subjected to bending deformation, and FIG. 58 is an explanatory view illustrating the frame member 6 in a state in which the frame member 6 is subjected to the bending deformation.

The electronic device 100 includes a flexible substrate 1, the sealing member 5, and the drip-proof member 7. Although the electronic device 100 according to the present embodiment is a so-called beacon device, the form of the electronic device 100 is not limited to this.

The flexible substrate 1 is formed of a rubber sheet and has flexibility. The flexible substrate 1 may be formed of another material as long as the material has flexibility. One surface of the flexible substrate 1 is a component mounting surface la over which solar cells 2 are mounted and which is provided with a circuit forming portion 3. Electronic components 3a, 3b, and the like operated by power supplied by the solar cells 2 are mounted over the circuit forming portion 3. The circuit forming portion 3 is formed by using electrically conductive metal paste. A sensor 4 electrically coupled to the electronic components 3a, 3b, and the like is mounted over the component mounting surface la. The sensor 4 according to the present embodiment measures an outside air temperature. Accordingly, the sensor 4 is mounted over the flexible substrate 1 in a state in which the sensor 4 is able to be in contact with the outside air. The sensor 4 is an example of a sensor that measures numerical values relating to the outside air. Alternatively, for example, a sensor that measures the humidity of the outside air may be mounted as the sensor 4, or a sensor capable of measuring the temperature and humidity of the outside air may be used as the sensor 4.

Since the sealing member 5 is formed of silicon rubber, the sealing member 5 has flexibility. Since the electronic device 100 according to the present embodiment includes the solar cells 2, the sealing member 5 has solar light transmitting properties to allow solar light to reach the solar cells 2. The sealing member 5 is joined to the flexible substrate 1 so as to cover the component mounting surface la. Thus, the solar cells 2 and the circuit forming portion 3 are covered with the sealing member 5.

Referring to FIGS. 2 to 3B, the sealing member 5 has a top surface 51, a front surface 52, and a bottom surface 53. The top surface 51 and the bottom surface 53 are parallel to a light receiving surface of the solar cells 2. The bottom surface 53 is joined to the component mounting surface la. The front surface 52 is continuous with the top surface 51 and the bottom surface 53. The thickness of the sealing member 5 appears on the front surface 52. The sealing member 5 has a recessed sensor accommodating portion 5a on the bottom surface 53 side. The front surface 52 of the sealing member 5 is provided with the opening 5a1 that allows communication between the inside and outside of the sensor accommodating portion 5a. Thus, the outside air is introduced into the sensor accommodating portion 5a, and accordingly, the sensor 4 disposed inside is in the state in which the sensor 4 is able to be in contact with the outside air. The drip-proof member 7 is attached to the opening 5a1. The electronic device 100 obtains the power when the solar cells 2 are irradiated with solar light. Accordingly, the electronic device 100 is preferably used in a state in which the top surface 51 side faces the sun side, for example, faces upward. Thus, the drip-proof properties may be improved by disposing the opening 5a1 communicating with the sensor accommodating portion 5a in the front surface and attaching the drip-proof member 7 to the opening 5a1.

The electronic device 100 according to the present embodiment, which is equipped with the solar cells 2, is able to be operated free of a battery. However, the electronic device 100 may be equipped with a battery instead of the solar cells 2. In this case, the sealing member 5 does not necessarily have the solar light transmitting properties. The sealing member 5 may be formed of a material other than silicon rubber as long as the material is able to provide flexibility.

The drip-proof member 7 is formed of an air permeable film-shaped material. For example, the drip-proof member 7 is formed of a material such as Gore-Tex (registered trademark) that includes a water vapor transmitting film, for example, a water vapor transmitting film which allows water vapor to pass through the water vapor transmitting film but does not allow water droplets to pass through the water vapor transmitting film. Such a drip-proof member 7 is poor in stretchability. The drip-proof member 7 has slits 7a as deformation allowing portions able to follow the deformation of the sealing member 5. As illustrated in FIG. 4, the drip-proof member 7 according to the present embodiment is stuck to the frame member 6 and, when the frame member 6 is fitted into the opening 5a1 as illustrated in FIG. 2, attached to the opening 5a1. The frame member 6 is molded from silicon rubber similarly to the sealing member 5. The frame member 6 has a block shape. When the frame member 6 is fitted into the opening 5a1, the frame member 6 serves as part of the sealing member 5. In this case, the drip-proof member 7 is stuck to the surface of the frame member 6. However, the drip-proof member 7 may be directly stuck to the sealing member 5, without using the frame member 6, with a region around the opening 5a1 used as a bonding portion. According to the present embodiment, the frame member 6 is fitted into the opening 5a1, held in the opening 5a1 by frictional force generated between the frame member 6 and the sealing member 5, and integrated with the sealing member 5. Thus, water stopping properties may be ensured. However, the frame member 6 may be bonded at the opening 5a1 so as to be secured to the sealing member 5.

The frame member 6 according to the present embodiment has a plurality of vents 6a. The frame member 6 includes column portions 6b and bar portions 6c. When the frame member 6 is fitted into the opening 5a1, the column portions 6b extend in the thickness direction and the bar portions 6c extend in the direction intersecting the column portions 6b. Each vent 6a is formed in a space surrounded by the column portions 6b and the bar portions 6c. The plurality of vents 6a each allow communication between the inside and outside of the sensor accommodating portion 5a so as to maintain a function of an opening. The direction in which the bar portions 6c in an unbent state extend coincides with the direction in which a bending axis AX of the electronic device 100 extends. The electronic device 100 is able to be bent so as to cause the bending axis AX ending in the direction intersecting the thickness direction to flex.

The surfaces of the column portions 6b and the surfaces of the bar portions 6c serve as bonding surfaces for sticking the drip-proof member 7 to the frame member 6. The slits 7a are formed in portions of the drip-proof member 7 stuck to the sealing member 5. According to the present embodiment, the slits 7a are formed in portions of the drip-proof member 7 stuck to the column portions 6b of the frame member 6. For example, the slits 7a are formed in portions stuck to the column portions 6b which are interposed between the vents 6a.

The drip-proof member 7 of the present embodiment has a rectangular shape and has a first edge 71 and a second edge 72 opposite to each other. When the drip-proof member 7 is stuck to the frame member 6, the first edge 71 and the second edge 72 are disposed along the bar portions 6c that each extend in the bending axis AX direction. The slits 7a are provided at the first edge 71 and the second edge 72 opposite to each other as described above. The slits 7a provided at the first edge 71 extend toward the second edge 72. The slits 7a provided at the second edge 72 extend toward the first edge 71. For example, each slit 7a extends in the thickness direction.

The frame member 6 may be in the unbent state as illustrated in FIG. 5A or in a state in which the frame member 6 is deformed so as to bend the bending axis AX as illustrated in FIG. 5B. When the drip-proof member 7 is stuck to the frame member 6 (sealing member 5) without such slits 7a, the drip-proof member 7 may be peeled off or break due to poor stretchability of the drip-proof member 7. In contrast, according to the present embodiment, even when the frame member 6 is deformed, the slits 7a are opened. Thus, removal of the drip-proof member 7 from the frame member 6 (sealing member 5) resulting from peeling off of the drip-proof member 7 may be avoided and damage to the drip-proof member 7 may be avoided. The reason for this is that, with the slits 7a, the portions of the drip-proof member 7 that are disposed on both sides of each slit 7a and stuck to the frame member 6 are separated from each other when the frame member 6 (sealing member 5) is subjected to bending deformation. This allows changes in the shape of the entire drip-proof member 7. When the bending deformation of the electronic device 100 is restored to the original state, the slits 7a are closed and the drip-proof member 7 is also restored to the original state.

The slits 7a are provided at the first edge 71 and the second edge 72. When the electronic device 100 is bent in either direction, the slits 7a provided at one or the other edge are opened in accordance with the bending direction. Thus, removal of the drip-proof member 7 resulting from peeling off of the drip-proof member 7 may be avoided and damage to the drip-proof member 7 may be avoided.

According to the present embodiment, the plurality of slits 7a are arranged along each of the first edge 71 and the second edge 72. This may increase the amount of allowable deformation. This may increase the effect of avoiding removal of the drip-proof member 7 resulting from peeling off of the drip-proof member 7 and the effect of avoiding damage to the drip-proof member 7.

In FIG. 5B, for ease of understanding the state of deformation in regions near the slits 7a, the opening state of the slits 7a and the shape of the deformed drip-proof member 7 are illustrated in an exaggerated manner. Thus, FIG. 5B does not exactly represent the shape of the deformed drip-proof member 7.

Although the drip-proof member 7 according to the present embodiment is attached to the opening 5a1 by using the frame member 6, the drip-proof member 7 may be directly stuck to the periphery of the opening 5a1 without using the frame member 6. In so doing, portions corresponding to the column portions 6b provided in the frame member 6 may be provided in the opening 5a1. In this case, the slits 7a may be disposed in these portions.

### Second Embodiment

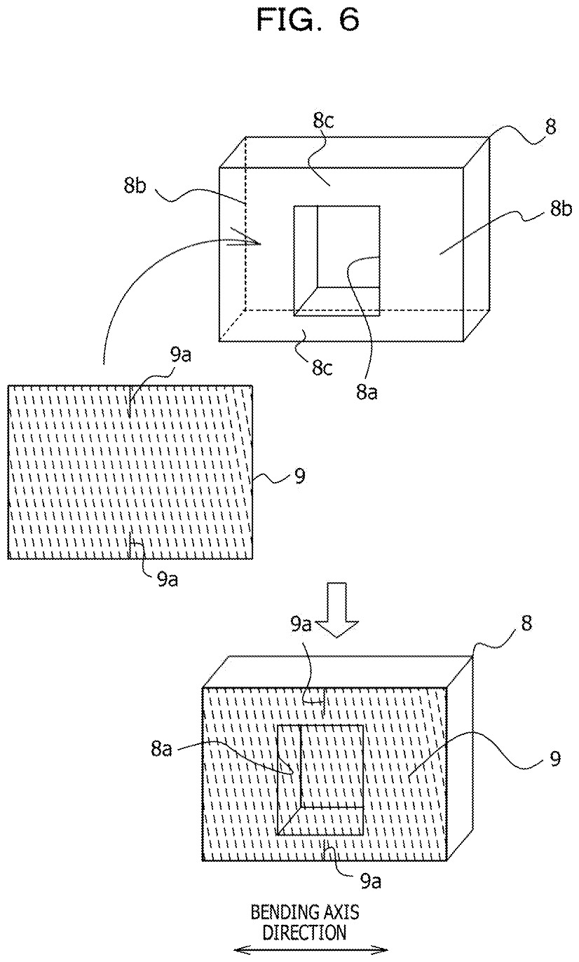

Next, referring to FIG. 6, a second embodiment is described. FIG. 6 is an explanatory view of a frame member 8 and a drip-proof member 9 according to the second embodiment. According to the second embodiment, the frame member 8 is employed instead of the frame member 6 according to the first embodiment. The frame member 8 has a single vent 8a. The vent 8a has two column portions 8b and two bar portions 8c. Each bar portion 8c couples an end portion of one of the column portions 8b to an end portion of the other column portion 8b. For example, the vent 8a is formed in a space surrounded by two column portions 8b and two bar portions 8c.

The surfaces of the column portions 8b and the surfaces of the bar portions 8c serve as bonding surfaces to which the drip-proof member 9 is stuck. The drip-proof member 9 is formed of the same material as the material of the drip-proof member 7 according to the first embodiment. Slits 9a are provided at the opposite edges of the drip-proof member 9, respectively. Although the slits 7a according to the first embodiment are disposed so as to correspond to the column portions 6b that separate the vents 6a from each other, the slits 9a according to the present embodiment is disposed over the bar portions 8c. Even when the column portions that separate the vents from each other are not provided as described above, with the slits 9a provided in the drip-proof member 9, the drip-proof member 9 is able to follow deformation of the frame member 8 (sealing member 5) so as to allow the deformation of the frame member 8. As a result, removal of the drip-proof member 9 resulting from peeling off of the drip-proof member 9 may be avoided and damage to the drip-proof member 9 may be avoided.

### Third Embodiment

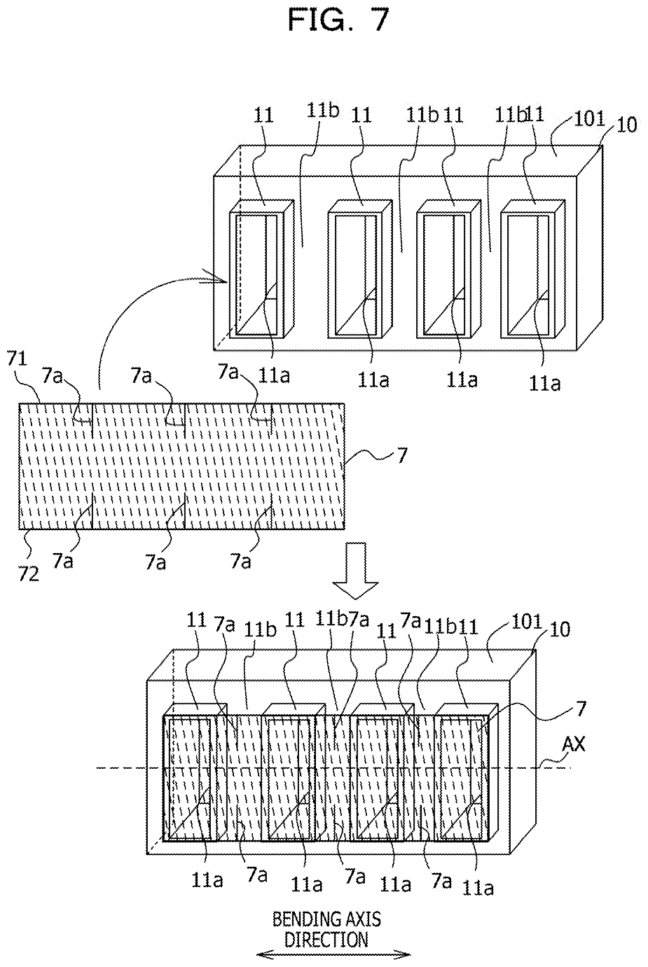

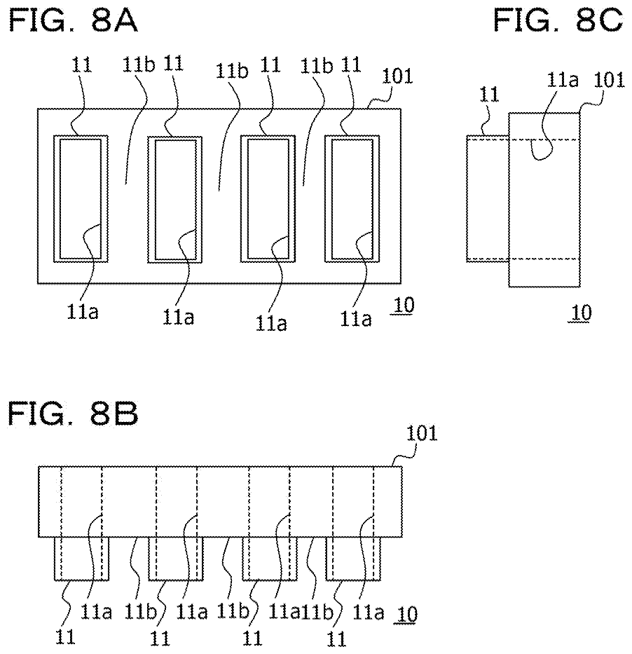

Next, referring to FIGS. 7 to 8C, a third embodiment is described. FIG. 7 is an explanatory view of a frame member 10 and the drip-proof member 7 according to the third embodiment. FIGS. 8A to 8C are a three-view drawing of the frame member 10 according to the third embodiment.

According to the third embodiment, the frame member 10 is provided instead of the frame member 6 according to the first embodiment. The frame member 10 is formed of a material similar to the material of the frame member 6. When the frame member 10 is fitted into the opening 5a1 provided in the sealing member 5, the frame member 10 serves as part of the sealing member 5.

The frame member 10 includes a main body portion 101 and a plurality of bay window-shaped portions 11 that project outward from the main body portion 101 and form respective vents 11a. The vents 11a each maintain the function of the opening. Recessed portions 11b are formed between the adjacent bay window-shaped portions 11. When such a frame member 10 is fitted into the opening 5a1 of the sealing member 5, the sealing member 5 includes a structure that includes the plurality of bay window-shaped portions forming the respective vents 11a and the recessed portions formed between the adjacent bay window-shaped portions.

The drip-proof member 7 similar to the drip-proof member 7 according to the first embodiment is provided over the frame member 10 (sealing member 5). The drip-proof member 7 has the slits 7a serving as the deformation allowing portions, and the slits 7a are provided in portions where the recessed portions 11b are located. For example, the drip-proof member 7 is attached to the frame member 10 by using an end surface of each bay window-shaped portion 11 as a bonding surface. In so doing, the slits 7a are disposed in the portions where the recessed portions 11b are located.

When the plurality of independent bay window-shaped portions 11 are provided and the drip-proof member 7 is provided on distal end sides of the bay window-shaped portions 11 as described above, the likelihood of transfer of deformation of the sealing member 5 to the drip-proof member 7 may be reduced. Even when the deformation of the sealing member 5 is transferred to the drip-proof member 7, the slits 7a are opened. Thus, removal of the drip-proof member 7 resulting from peeling off of the drip-proof member 7 may be avoided and damage to the drip-proof member 7 may be avoided. The slits 7a are disposed in the portions where the recessed portions 11b are located, and the periphery of each slit 7a is not bonded, so that the slit 7a is in a state in which the slit 7a is provided so as to be spaced from the surface of the sealing member 5. This may realize a state in which the deformation is easily allowed.

This may also increase the effect of avoiding removal of the drip-proof member 7 resulting from peeling off of the drip-proof member 7 and the effect of avoiding damage to the drip-proof member 7,

Although the bay window-shaped portions 11 project toward the outside of the sensor accommodating portion 5a according to the present embodiment, the bay window-shaped portions 11 may project toward the inside of the sensor accommodating portion 5a. Alternatively, the bay window-shaped portions 11 and the recessed portions 11b may be formed in a wall portion of the sealing member 5 including the front surface 52 without using the frame member 10.

### Fourth Embodiment

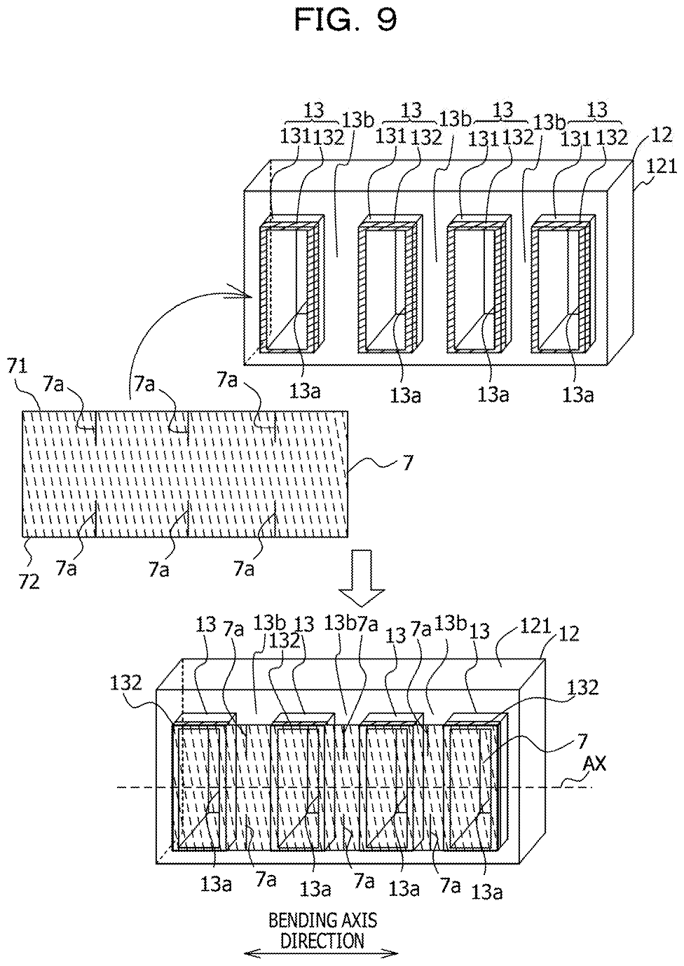

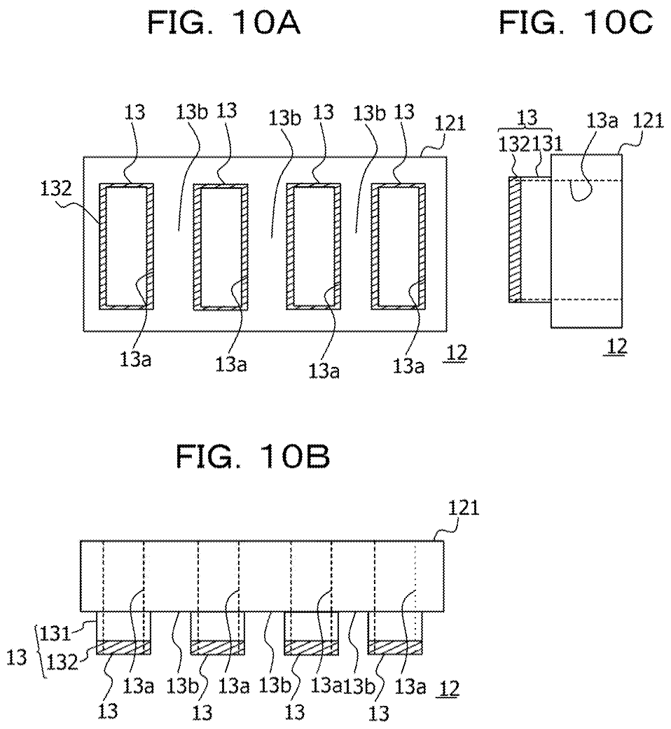

Next, referring to FIGS. 9 to 10C, a fourth embodiment is described. FIG. 9 is an explanatory view of a frame member 12 and the drip-proof member 7 according to the fourth embodiment. FIGS. 10A to 10C are a three-view drawing of the frame member 12 according to the fourth embodiment.

According to the fourth embodiment, the frame member 12 is provided instead of the frame member 10 according to the third embodiment. Whereas the bay window-shaped portions 11 of the frame member 10 are formed of the same material as the material of the main body portion 101, in bay window-shaped portions 13 of the frame member 12, distal end portions 132 are formed of a material having a higher rigidity than the rigidity of the material of proximal end portions 131. For example, the proximal end portions 131 continuous with a main body portion 121 are formed of the same material as the material of the main body portion 121 (silicon rubber), and the distal end portions 132 are formed of a resin having a higher rigidity than the rigidity of silicon rubber. The proximal end portions 131 and the distal end portions 132 are able to be integrally molded by, for example, two-color molding. Similarly to the frame member 10, when the frame member 12 is fitted into the opening 5a1 provided in the sealing member 5, the frame member 12 serves as part of the sealing member 5. The bay window-shaped portions 13 have respective vents 13a (openings).

The drip-proof member 7 similar to the drip-proof member 7 according to the third embodiment is provided over the frame member 12 (sealing member 5). The drip-proof member 7 has the slits 7a serving as the deformation allowing portions, and the slits 7a are provided in portions where recessed portions 13b are located. The drip-proof member 7 is stuck to the frame member 12 by using an end surface of the distal end portion 132 of each bay window-shaped portion 13 as a bonding surface. In so doing, the slits 7a are disposed in portions where the recessed portions 13b are located.

As described above, the drip-proof member 7 is stuck to the distal end portions 132 having a higher rigidity than the rigidity of the proximal end portions 131. This may reduce the likelihood of the drip-proof member 7 being influenced by deformation of the sealing member 5 or the proximal end portions 131. As a result, removal of the drip-proof member 7 resulting from peeling off of the drip-proof member 7 may be avoided and damage to the drip-proof member 7 may be avoided.

In FIGS. 9 to 10C, for ease of recognition of the distal end portions 132, the distal end portions 132 are hatched.

### Fifth Embodiment

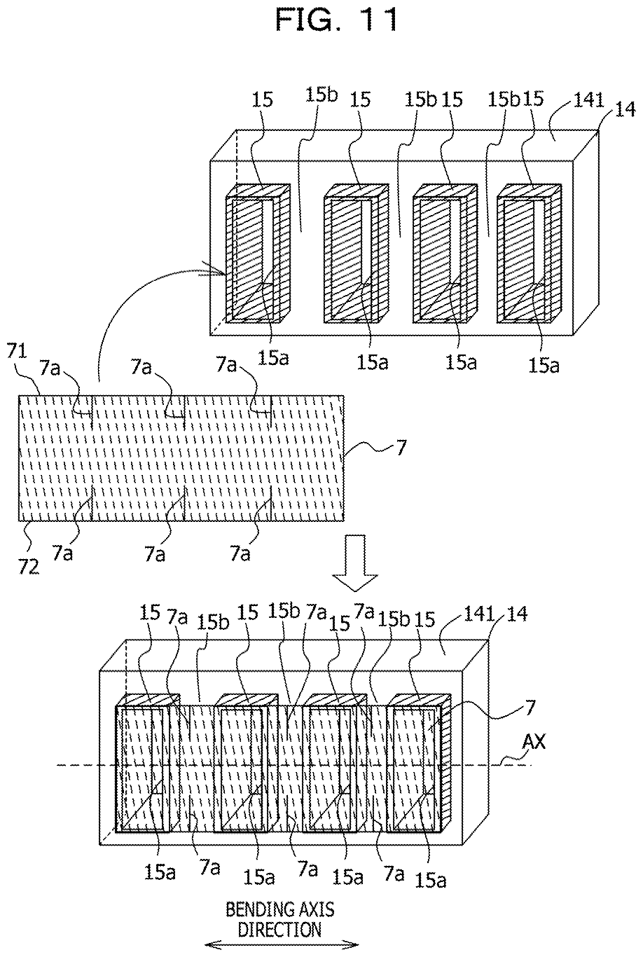

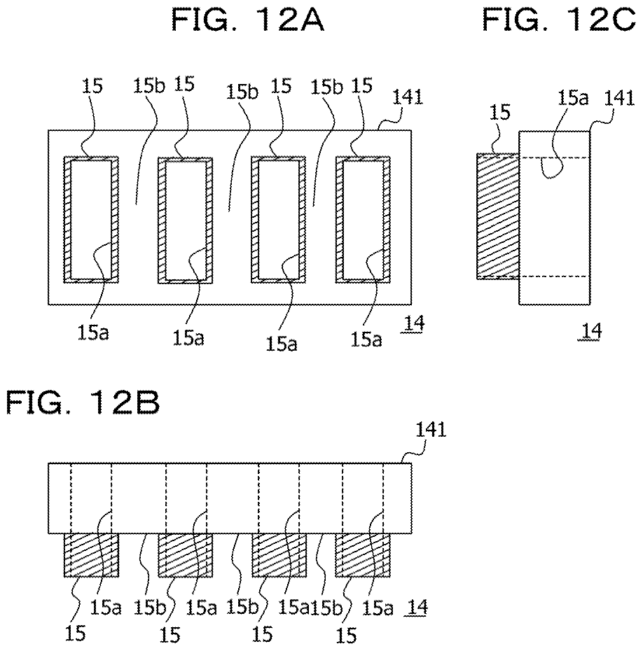

Next, referring to FIGS. 11 to 12C, a fifth embodiment is described.

FIG. 11 is an explanatory view of a frame member 14 and the drip-proof member 7 according to the fifth embodiment. FIGS. 12A to 12C are a three-view drawing of the frame member 14 according to the fifth embodiment.

In the fifth embodiment, the frame member 14 is provided instead of the frame member 12 according to the fourth embodiment. The bay window-shaped portions 13 of the frame member 12 include the proximal end portions 131 and the distal end portions 132 having a higher rigidity than the rigidity of the proximal end portions 131. Unlike the bay window-shaped portions 13, the entirety of each bay window-shaped portion 15 of the frame member 14 is formed of a resin having a higher rigidity than the rigidity of a main body portion 141 formed of silicon rubber. The frame member 14 serves as part of the sealing member 5 when the frame member 14 is fitted into the opening 5a1. Thus, the main body portion 141 corresponds to a portion of the sealing member 5 continuous with the bay window-shaped portions 15. The main body portion 141 and the bay window-shaped portions 15 are able to be integrally molded by, for example, two-color molding. Similarly to the frame member 12, when the frame member 14 is fitted into the opening 5a1 provided in the sealing member 5, the frame member 14 serves as part of the sealing member 5. The bay window-shaped portions 15 have respective vents 15a (openings).

The drip-proof member 7 similar to the drip-proof member 7 according to the fourth embodiment is provided over the frame member 14 (sealing member 5). The drip-proof member 7 has the slits 7a serving as the deformation allowing portions, and the slits 7a are provided in portions where recessed portions 15b are located. The drip-proof member 7 is stuck to the frame member 14 by using an end surface of each bay window-shaped portion 15 as a bonding surface. In so doing, the slits 7a are disposed in portions where the recessed portions 15b are located.

As described above, the drip-proof member 7 is stuck to the bay window-shaped portions 15 having a higher rigidity than the rigidity of the main body portion 141. This may reduce the likelihood of the drip-proof member 7 being influenced by deformation of the sealing member 5. As a result, removal of the drip-proof member 7 resulting from peeling off of the drip-proof member 7 may be avoided and damage to the drip-proof member 7 may be avoided.

In FIGS. 11 to 12C, for ease of recognition of the bay window-shaped portions 15, the bay window-shaped portions 15 are hatched.

### Sixth Embodiment

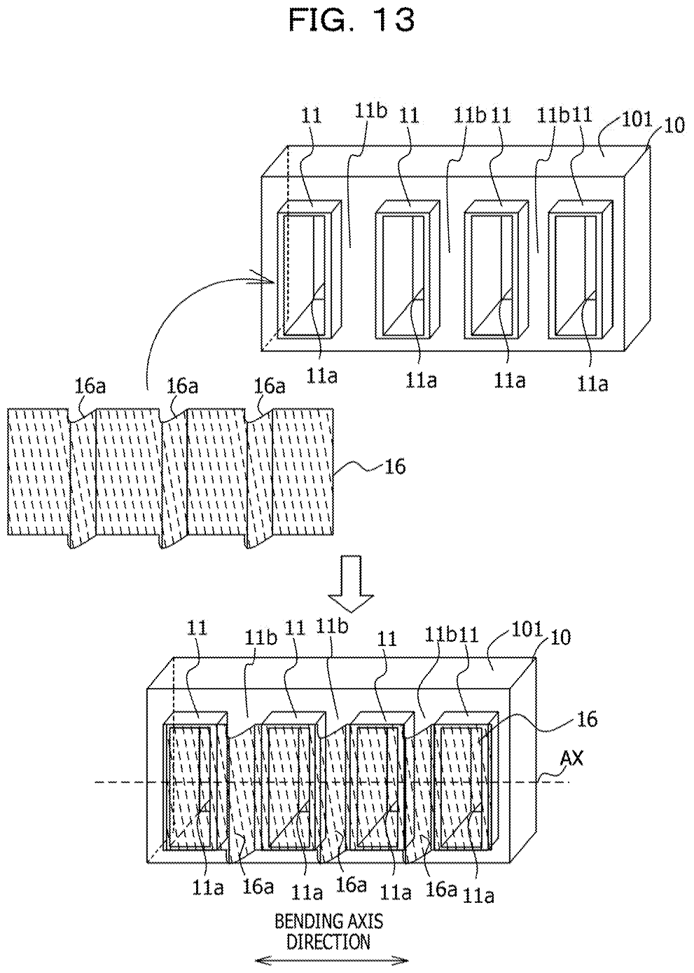

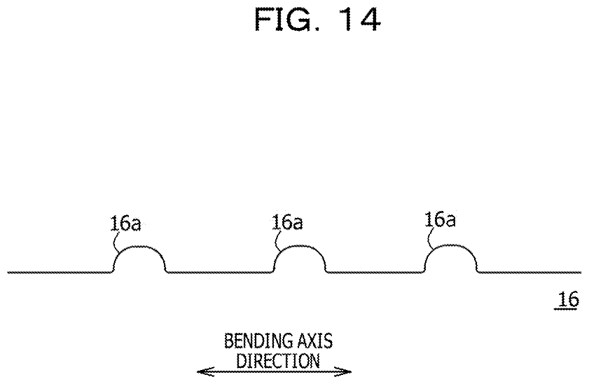

Next, referring to FIGS. 13 and 14, a sixth embodiment is described. FIG. 13 is an explanatory view of the frame member 10 and a drip-proof member 16 according to the sixth embodiment. FIG. 14 is a bottom view of the drip-proof member 16 according to the sixth embodiment.

According to the sixth embodiment, the drip-proof member 16 is provided instead of the drip-proof member 7 according to the third embodiment. The drip-proof member 16 is formed of a material similar to the material of the drip-proof member 7 and has flexing portions 16a instead of the slits 7a as the deformation allowing portions. The frame member 10 is the same as the frame member 10 according to the third embodiment and includes the bay window-shaped portions 11 and the recessed portions 11b. Similarly to the drip-proof member 7, the drip-proof member 16 is stuck to the end surfaces of the bay window-shaped portions 11, In so doing, the flexing portions 16a are provided in portions where the recessed portions 11b are located. Thus, the flexing portions 16a are disposed so as to be spaced from the surface of the frame member 10 that is to serve as part of the sealing member 5. The length of edges of the flexing portions 16a is greater than the width of the recessed portions 11b, for example, the linear distance between the adjacent bay window-shaped portions 11. Thus, even when the distance between the bay window-shaped portions 11 changes or relative positions of the bay window-shaped portions 11 change due to bending of the electronic device 100 (sealing member 5), the flexing portions 16a may accommodate the change in the distance or the positions. As a result, removal of the drip-proof member 16 resulting from peeling off of the drip-proof member 16 may be avoided and damage to the drip-proof member 16 may be avoided.

The drip-proof member 16 may be combined with a form in which, as is the case with the first embodiment, the bay window-shaped portions are not provided, a form in which, as is the case with the fourth embodiment, the rigidity of the distal end portions 132 of the bay window-shaped portions 13 is increased, or a form in which, as is the case with the fifth embodiment, the rigidity of the bay window-shaped portions 15 is increased.

### Seventh Embodiment

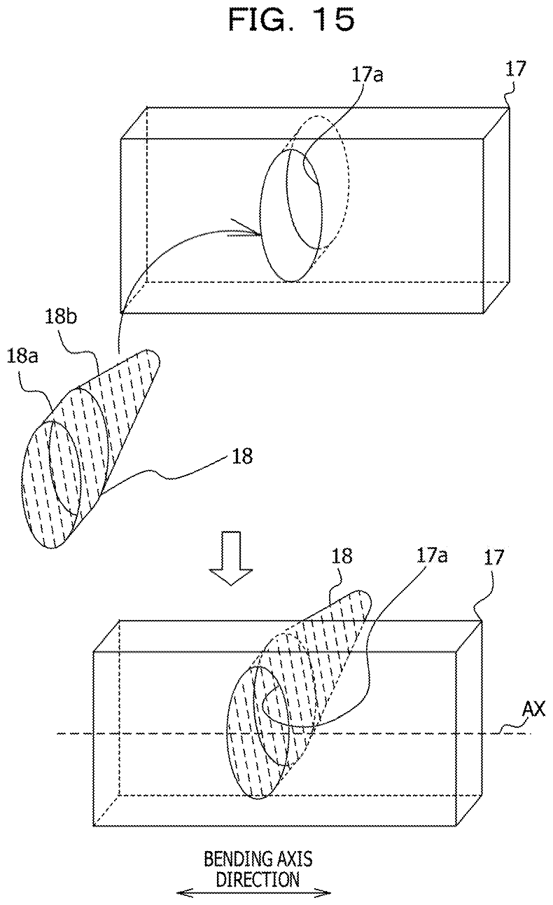

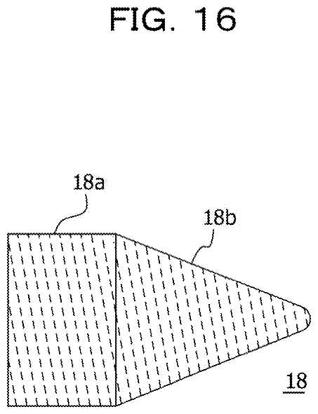

Next, referring to FIGS. 15 to 17, a seventh embodiment is described. FIG. 15 is an explanatory view of a frame member 17 and a drip-proof member 18 according to the seventh embodiment. FIG. 16 is a side view of the drip-proof member 18 attached to the frame member 17 according to the seventh embodiment. FIG, 17 is a side view of a drip-proof member 19 according to a modification.

According to the seventh embodiment, the frame member 17 and the drip-proof member 18 are provided instead of the frame member 6 and the drip-proof member 7 according to the first embodiment.

Similarly to the frame member 6 according to the first embodiment, when the frame member 17 is fitted into the opening 5a1 provided in the sealing member 5, the frame member 17 serves as part of the sealing member 5. The frame member 17 is molded from silicon rubber similarly to the sealing member 5. The frame member 17 has a vent 17a that maintains the function of the opening which allows communication between the inside and outside of the sensor accommodating portion 5a. Although the vent 17a has an elliptical shape, the vent 17a may have a circular shape.

The drip-proof member 18 is formed of a material similar to the material of the drip-proof member 7 and includes a cylindrical portion 18a and a bag-shaped portion 18b continuous with the cylindrical portion 18a. The bag-shaped portion 18b corresponds to a deformation allowing portion.

The cylindrical portion 18a has an annular shape and is joined to an inner peripheral wall surface of the vent 17a. Since the cylindrical portion 18a has an annular shape, the cylindrical portion 18a is able to follow changes in the shape of the vent 17a occurring when the frame member 17 is deformed. For example, although the material itself of the cylindrical portion 18a is poor in stretchability, the cylindrical portion 18a is able to follow the deformation of the frame member 17 (sealing member 5). The reason for this is not that the material itself of the cylindrical portion 18a is stretched, but that the shape of the cylindrical portion 18a is deformable.

The bag-shaped portion 18b is shaped such that the bag-shaped portion 18b separates the inside and outside of the sensor accommodating portion 5a from each other and has dimensions with margins so as to allow the deformation of the cylindrical portion 18a continuous with the bag-shaped portion 18b. As a result, peeling off of the drip-proof member 18 and damage to the drip-proof member 18 may be avoided.

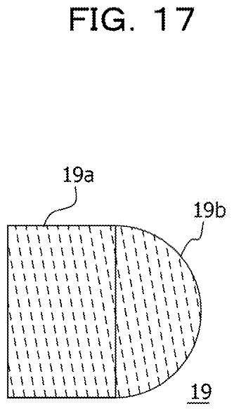

The bag-shaped portion 18b according to the present embodiment has a triangular pyramid shape. However, as is the case with the drip-proof member 19 illustrated in FIG. 17, a form in which a cylindrical portion 19a is provided with a bag-shaped portion 19b having a dome shape may be used. For example, it is sufficient that the bag-shaped portion have dimensions and a shape that are able to allow deformation of the cylindrical portion.

The cylindrical portion 18a of the drip-proof member 18 may be stuck to an inner peripheral wall of the opening 5a1 provided in the sealing member 5 without using the frame member. In this case, however, the opening 5a1 desirably has a shape without a corner such as a circular shape or an elliptical shape so as to reduce the likelihood of peeling off of the cylindrical portion 18a.

Although the preferred embodiments according to the present disclosure have been described in detail above, the present disclosure is not limited to the particular embodiments, and various modifications and changes may be made within the scope of the gist of the present disclosure described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic device comprising:
a flexible substrate which has flexibility and in which an electronic component and a sensor coupled to the electronic component are mounted over a component mounting surface;
a sealing member which has flexibility, which has a sensor accommodating portion provided so as to correspond to a mounting position of the sensor, which also has at least one opening that allows communication between inside and outside of the sensor accommodating portion, and which covers at least the component mounting surface of the flexible substrate; and
a drip-proof member which has air permeability, which has at least one deformation allowing portion configured to follow deformation of the sealing member, and which is stuck to the sealing member over the at least one opening.

2. The electronic device according to claim 1, wherein
the drip-proof member has a film shape, and the at least one deformation allowing portion is at least one slit able to be opened and closed when the sealing member is deformed.

3. The electronic device according to claim 2, wherein
the at least one slit is formed in a portion stuck to the sealing member.

4. The electronic device according to claim 3, wherein
part of the drip-proof member is stuck to a column portion that divides the at least one opening, and the at least one slit is formed in a portion stuck to the column portion.

5. The electronic device according to claim 1, wherein
the drip-proof member is provided over a block-shaped frame member that has a vent which allows communication between the inside and the outside of the sensor accommodating portion and that forms, when the frame member is fitted into the at least one opening, part of the sealing member.

6. The electronic device according to claim 2, wherein
the at least one slit includes a plurality of slits, and wherein
the plurality of slits are provided at one and another of opposite edges of the drip-proof member such that one or more of the plurality of slits extend from the one toward the other of the opposite edges and a slit or slits of the plurality of slits other than the one or more of the plurality of slits extend from the other toward the one of the opposite edges.

7. The electronic device according to claim 1, wherein
the at least one deformation allowing portion is a flexing portion provided so as to be spaced from a surface of the sealing member.

8. The electronic device according to claim 1, wherein
the at least one opening includes a plurality of openings, wherein
the sealing member includes a plurality of bay window-shaped portions that form the plurality of openings, respectively, wherein
the sealing member has a recessed portion formed between the adjacent bay window-shaped portions, and wherein
the at least one deformation allowing portion is provided at a portion where the recessed portion is located.

9. The electronic device according to claim 8, wherein
rigidity of distal end portions of the plurality of bay window-shaped portions is higher than rigidity of proximal end portions of the plurality of bay window-shaped portions.

10. The electronic device: according to claim 8, wherein
rigidity of the plurality of bay window-shaped portions is higher than rigidity of a portion of the sealing member continuous with the plurality of bay window-shaped portions.

11. The electronic device according to claim 1, wherein
the drip-proof member includes a cylindrical portion joined to an inner peripheral surface of the at least one opening provided in the sealing member, and wherein
the at least one deformation allowing portion is a bag-shaped portion continuous with the cylindrical portion.
